(19) United States
(12) Patent Application Publication
(10) Pub. No.: US 2016/0287915 A1
(43) Pub. Date: Oct. 6, 2016

(54) Protective Breathing Mask with the Collective Inhalation and Exhalation Hole

(71) Applicant: TECHNICKÁ UNIVERZITA V LIBERCIKATEDRA STROJÍRENSKÉ TECHNOLOGIE ODDELENÍ TVÁRENÍ KOVU A ZPRACOVÁNÍ, Liberec 1 (CZ)

(72) Inventors: Petr Lenfeld, Liberec (CZ); Jiri Bobek, Liberec (CZ); Martin Seidl, Hradec Králové (CZ); Lubos Behálek, Liberec 15 (CZ); Jiri Habr, Zelezný Brod (CZ)

(73) Assignee: TECHNICKÁ UNIVERZITA V LIBERCIKATEDRA STROJÍRENSKÉ TECHNOLOGIE ODDELENÍ TVÁRENÍ KOVU A ZPRACOVÁNÍ, Liberec 1 (CZ)

(21) Appl. No.: 15/031,915

(22) PCT Filed: Jul. 15, 2014
(86) PCT No.: PCT/CZ2014/000082

§ 371 Date: Apr. 25, 2016

(30) Foreign Application Priority Data
Oct. 25, 2013 (CZ) PV 2013-826

(51) Int. Cl. A62B 23/02; A62B 18/02

(52) U.S. Cl. CPC A62B 23/02; A62B 18/02

(57) ABSTRACT

The protective breathing mask with collective inhalation and exhalation hole is equipped with at least one hole, which serves at the same time to exhale and inhale and filter capability is achieved by using the removable filter consisting of nanofibre filter fabric.

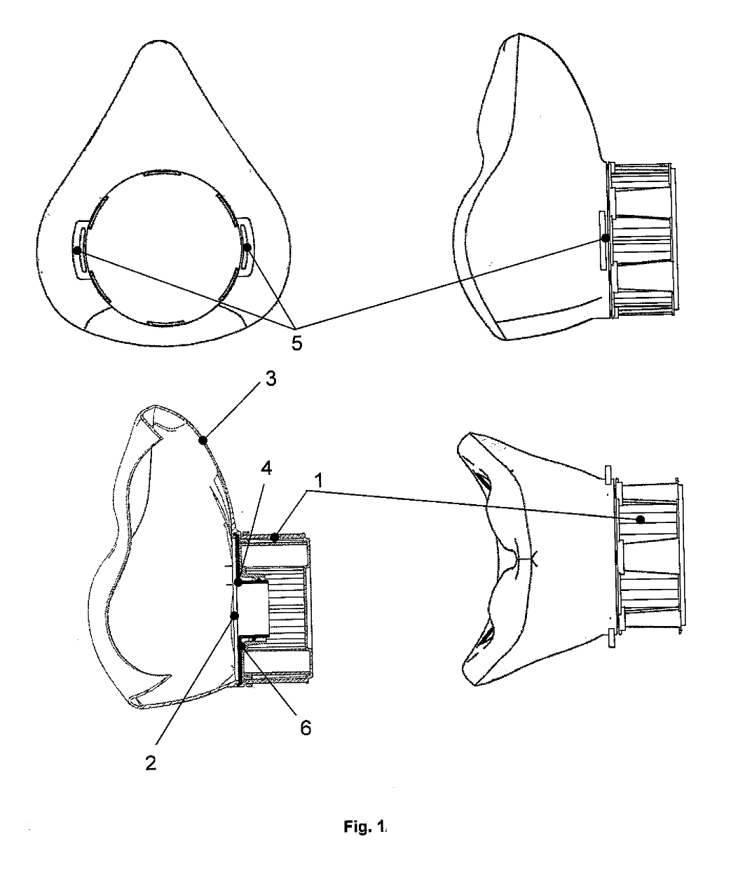

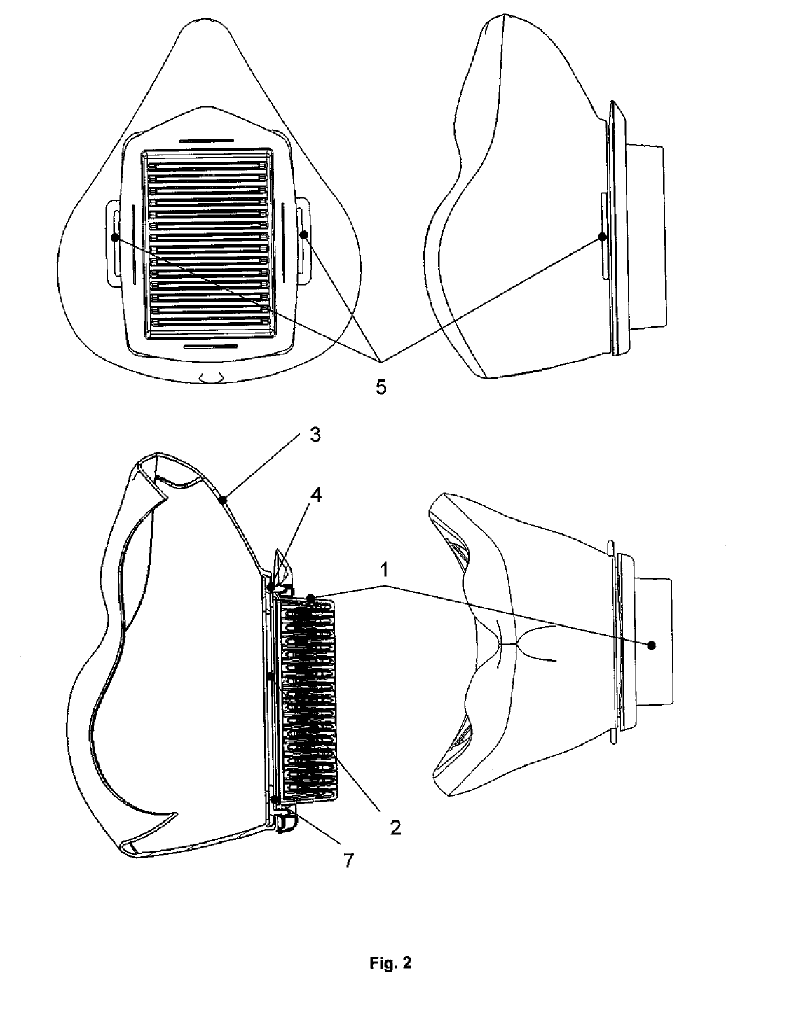

### TECHNOLOGY AREA

The invention relates to a protective breathing mask with collective inhalation and exhalation hole provided with nanofibre filter that allows hi-directional flow of inhaled and exhaled air. Protective breathing mask is made by two-component injection.

### PRESENT CONDITION OF TECHNOLOGY

Currently there are protective masks that usually contain at least one inhalation hole and at least one exhalation hole on the body of mask, when the exhalation contains a flexible membrane that prevents the intrusion of unfiltered air into the mask and thus into the respiratory system of man using a protective mask when breathing. When exhalation this membrane is pushed away by the pressure of exhaled air and exhaled air leaks by exhalation hole, because the current structures of the filters do not allow sufficient airflow when inhalation and exhalation. From the technological point of view the current protective masks are manufactured as individual parts, which are subsequently assembled into the final product. The proposed design solution uses the technology of two-component injection for obtaining the body of the protective mask (flexible part 3 and rigid part 4), to which the circular or rectangular filter is connected, according to the option solutions.

### PRINCIPLE OF TECHNICAL SOLUTION

Presented solution allows using only one hole for air flow on the body of mask when inhalation and exhalation because of use of the nanofibre filter and filter capability of the mask is preserved. Filter ability of the mask is given by the type of used nanofibre filter that can be defined for different filtration purposes and in particular with regard to the size and nature of the filtered particles.

### EXAMPLES OF TECHNICAL SOLUTION CONDUCT

Presented solution allows using only one hole 2 for air flow on the body of mask when inhalation and exhalation because of use of the nanofibre filter 1 and filter capability of the mask is preserved. Filter ability of the mask is given by the type of used nanofibre filter that can be defined for different filtration purposes and in particular with regard to the size and nature of the filtered particles.

In this design the mask is composed of flexible part 3 and rigid part 4. Rigid part 4 is used to connect the filter 1 and is equipped with fastening lugs 5 to clamp the protective mask to face using rubberized fabric stitched ribbon. Flexible part 3 is due to the sealing on the border of face mask equipped with sealing hem, which is typically used for this purpose. Seal between the filter 1 is carried out using a flexible “o” ring 6, which is part of the filter 1 and by its grip between the sealing up in this area happens, or the removable flexible “o” ring is replaced with an integrated sealing element 7, which is on the rigid part of the mask 4 and again it is gripped between the surface of the filter 1 and the surface of the rigid part 4 and thus the mutual sealing occurs.

### INDUSTRIAL EFFICIENCY

The presented solution of the protective mask fitted with only one hole collectively used for inhalation and exhalation of air represents a significant simplification of the production process of protective breathing masks and thus it has a direct impact not only on the reduction of production costs on a protective breathing mask, but while maintaining the same filtering capability it reduces the need for removable filters and thus the price of operating costs is reduced when using the mask. Further, the protective breathing mask with only one hole collectively used for inhalation and exhalation of air offers greater security with regard to possible leaks in comparison with protective masks with exhalation hole and the membrane when the interface between the membrane and its sealing surface is potentially risk with regard to the possible penetration of the filtered particles into space of the filtered air and thus into the respiratory system of man.

1. The protective breathing mask with collective inhalation and exhalation hole wherein the protective breathing mask is equipped with at least one hole (2), which serves at the same time to exhale and inhale and filter capability is achieved by using the removable filter (1) consisting of nanofibre filter fabric.

2. The protective breathing mask with collective inhalation and exhalation hole according to claim 1, wherein the protective breathing mask is made by the technology of two-component injection.
